(19) United States
(12) Patent Application Publication
(10) Pub. No.: US 2006/0169201 A1
(43) Pub. Date: Aug. 3, 2006

(54) Apparatus for supplying gas and apparatus for forming a layer having the same

(76) Inventors: Wan-Goo Hwang, Gyeonggi-do (KR); Seung-Ki Chae, Seoul (KR); Myeong-Jin Kim, Gyeonggi-do (KR); Seoung-Chang Baek, Gyeonggi-do (KR); Sung-Wook Park, Gyeonggi-do (KR); Un-Chan Baek, Gyeonggi-do (KR); Hyun-Wook Lee, Gyeonggi-do (KR); Kyoung-Ho Jang, Gyeonggi-do (KR); Seong-Ju Choi, Gyeonggi-do (KR); Il-Kyoung Kim, Gyeonggi-do (KR)

Correspondence Address: MARGER JOHNSON & MCCOLLOM, P.C., 210 SW MORRISON STREET, SUITE 400, PORTLAND, OR, 97204, US

(21) Appl. No.: 11/346,549

(22) Filed: Feb. 1, 2006

(30) Foreign Application Priority Data
Feb. 1, 2005 (KR) 2005-09177

(51) Int. Cl. B05B 7/00

(52) U.S. Cl. 118/300

(57) ABSTRACT

In a gas supplying apparatus used to form a layer on a substrate, a liquid reactant is introduced into an atomizer through a liquid mass flow controller and an on-off valve. An aerosol mist formed by the atomizer is introduced into a vaporizer and then vaporized. The on-off valve is coupled with the atomizer and controlled by a valve controller of the liquid mass flow controller. The on-off valve is opened to form the layer and closed during downtime of a layer formation apparatus to prevent leakage of the remaining liquid reactant in a connecting conduit between the liquid mass flow controller and the on-off valve.

### CROSS REFERENCE TO RELATED APPLICATION

This application claims the benefit under 35 U.S.C. §119 of Korean Patent Application No. 2005-9177 filed on Feb. 1, 2005 the disclosure of which is hereby incorporated herein by reference in its entirety as if set forth fully herein.

### BACKGROUND OF THE INVENTION

1. Field of the Invention

The present invention relates to an apparatus for supplying gas and an apparatus for forming a layer having the same. More particularly, the present invention relates to an apparatus for vaporizing liquid reactant in order to supply gas reactant for forming a layer onto a semiconductor substrate and an apparatus for forming the layer having the same.

2. Description of the Related Art

A semiconductor device is manufactured by repeatedly performing a plurality of processes on a semiconductor wafer used as a substrate. For example; a layer formation process is performed to form a layer on the substrate; an oxidation process is performed to form an oxide layer on the substrate or to oxidize a layer formed on the substrate; a photolithography process is performed to form a layer on the substrate into desired patterns; a planarization process is performed to planarize a layer formed on the substrate.

Various layers are formed on the substrate by means of a chemical vapor deposition (CVD), a physical vapor deposition (PVD), an atomic layer deposition (ALD), or the like. For example, a silicon oxide layer is used as a gate insulating layer or an interlayer insulating layer of the semiconductor device and is formed using the CVD process. A silicon nitride layer may be used as a mask pattern or a gate spacer and is formed using the CVD process. Furthermore, a plurality of layers, such as a metal layer used as a metal wiring or an electrode, a metal nitride layer used as a barrier layer or an ohmic layer, and the like, may be formed using the CVD process, the PVD process or the ALD process.

When the layers are formed on the substrate using the CVD or ALD process, various reactants may be used. The reactants are commonly introduced in gaseous phase into a reaction chamber, and the layers are formed by reaction between the reactants and a surface of the substrate.

When a reactant exists in liquid phase at a room temperature, the reactant is converted into gaseous phase by means of a gas supply system. For example, the liquid reactant is formed into a gas reactant by a bubbler system. Particularly, an inert gas is bubbled in a pool of the liquid reactant in a container, and thus the liquid reactant is vaporized. However, it is difficult to precisely control an amount of the gas reactant to be introduced into the reaction chamber when using the bubbler system.

In a liquid delivery system (LDS) including an injection valve, a gas reactant may be obtained by forming a liquid reactant into an aerosol mist and vaporizing the aerosol mist. In such case, a flow rate of the liquid reactant is measured by a liquid mass flow meter (LMFM) and adjusted based on the measured flow rate in the injection valve. However, operation of the injection valve is unstable because the injection valve is directly coupled to a heater heated to a temperature high enough to vaporize the aerosol mist. As a result, it is difficult to stably control the flow rate of the liquid reactant. In addition, build-up of undesirable residue occurs in and around an orifice of the injection valve.

On the contrary, in a LDS that includes a liquid mass flow controller (LMFC) for controlling a flow rate of a liquid reactant, an atomizer for forming the liquid reactant into an aerosol mist and a vaporizer for vaporizing the aerosol mist, solid reactants are extracted from the remaining liquid reactant in a connecting conduit between the LMFC and the atomizer during downtime of the liquid delivery system. The solid reactants are introduced in particulate form into the vaporizer and suspended in the gas reactant. When the gas reactant carrying the particulate contaminants is introduced into the reaction chamber during subsequent layer formation process, the semiconductor substrate is contaminated. Furthermore, the remaining liquid reactant is leaked into the vaporizer during loading and unloading the semiconductor substrate, and thus the gas reactant is unstably introduced into the reaction chamber in the early layer formation process.

### SUMMARY OF THE INVENTION

As described herein, a gas supplying apparatus has a liquid reactant supply section that is structured to supply a liquid reactant and an atomizer that is structured to form an aerosol mist from the liquid reactant. A liquid mass flow controller is disposed in a connecting conduit between the liquid reactant supply section and the atomizer and is structured to control a flow rate of the liquid reactant. A vaporizer is coupled to the atomizer and is structured to vaporize the aerosol mist formed by the atomizer to form a gas reactant. A valve is disposed in the connecting conduit adjacent to the atomizer and is structured to cooperate in combination with an operation of the liquid mass flow controller.

A gas supplying apparatus may be used in a layer forming apparatus as described herein. The layer forming apparatus includes a reaction chamber that is structured and arranged to receive a substrate to form a layer on the substrate and includes a substrate support disposed in the reaction chamber. The layer forming apparatus further includes a gas supply unit to supply a gas reactant into the reaction chamber to form the layer on the substrate. The gas supply unit has a liquid reactant supply section and an atomizer to form the liquid reactant into an aerosol mist. A liquid mass flow controller is disposed in a connecting conduit between the liquid reactant supply section and the atomizer to control a flow rate of the liquid reactant. A valve is disposed in the connecting conduit adjacent to the atomizer and is structured to cooperate in combination with an operation of the liquid mass flow controller. A vaporizer is coupled to the atomizer to vaporize the aerosol mist to form the gas reactant. The layer forming apparatus further includes a vacuum system connected to the reaction chamber to adjust an interior pressure of the reaction chamber, to remove by-products generated while forming the layer on the substrate and to remove a remaining gas reactant.

### BRIEF DESCRIPTION OF THE DRAWINGS

Example embodiments of the present invention will become readily apparent along with the following detailed description when considered in conjunction with the accompanying drawings wherein:

FIG. 1 is a schematic view illustrating an apparatus for supplying gas in accordance with an example embodiment of the present invention;

FIG. 2 is a cross-sectional view illustrating a liquid mass flow controller and an on-off valve as shown in FIG. 1;

FIG. 3 is a cross-sectional view illustrating a vaporizer as shown in FIG. 1;

FIG. 4 is a cross-sectional view illustrating another example of coupling relationship between an on-off valve and an atomizer as shown in FIG. 2; and

FIG. 5 is a schematic view illustrating an apparatus for forming a layer in accordance with another example embodiment of the present invention.

### DESCRIPTION OF THE INVENTION

Embodiments of the invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present. In contrast, when an element is referred to as being “directly on” another element, there are no intervening elements present. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first thin film could be termed a second thin film, and, similarly, a second thin film could be termed a first thin film without departing from the teachings of the disclosure.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompass both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, embodiments of the present invention will be explained in detail with reference to the accompanying drawings.

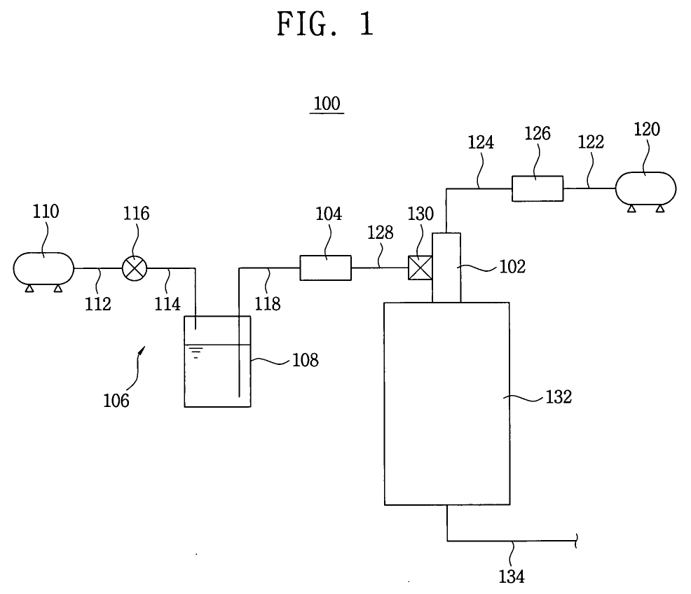

FIG. 1 is a schematic view illustrating an apparatus for supplying gas in accordance with an example embodiment of the present invention.

Referring to FIG. 1, an apparatus 100 for supplying gas forms a liquid reactant into an aerosol mist using a pressure drop and then obtains a gas reactant by heating the aerosol mist.

Particularly, an atomizer 102 is connected to a liquid mass flow controller 104 for controlling a flow rate of the liquid reactant in order to form the liquid reactant into the aerosol mist, and the liquid mass flow controller 104 is connected to a liquid reactant supply section 106 for supplying the liquid reactant.

The liquid reactant supply section 106 includes an airtight container 108 for receiving the liquid reactant and a source of compressed gas 110 for introducing a compressed gas into the container 108. The compressed gas source 110 is connected to the container 108 by a first gas supply conduit 112 and a second gas supply conduit 114. A pressure control valve 116 is disposed between the first and second gas supply conduits 112 and 114 and is operated in accordance with a pressure in the container 108. In detail, an opening degree of the pressure control valve 116 is adjusted based on the pressure in the container 108, and thus the pressure in the container 108 may be maintained evenly at a predetermined pressure.

The second gas supply conduit 114 is extended into the container 108 through an upper cover of the container 108, and an end portion of the second gas supply conduit 114 is disposed adjacent to the upper cover of the container 108. A first connecting conduit 118 for connecting the container 108 and the liquid mass flow controller 104 is extended into the container 108 through the upper cover of the container 108, and an end portion of the first connecting conduit 118 is disposed adjacent to a bottom surface of the container 118 so as to be immersed in a pool of the liquid reactant in the container 108.

The atomizer 102 is connected to a source of carrier gas 120 for supplying a carrier gas by a third gas supply conduit 122 and a fourth gas supply conduit 124. A mass flow controller 126 is disposed between the third and fourth gas supply conduits 122 and 124 to adjust a flow rate of the carrier gas. Examples of the compressed gas and the carrier gas may include nitrogen (N2), argon (Ar), helium (He), and the like.

A second connecting conduit 128 connects the liquid mass flow controller 104 and the atomizer 102, and an on-off valve 130 is disposed in the second connecting conduit 128 to cooperate in combination with operation of the liquid mass flow controller 104. The liquid reactant is introduced at a controlled flow rate by the liquid mass flow controller 104 into the atomizer 102 through the on-off valve 130. Particularly, the on-off valve 130 is disposed between the second connecting conduit 128 and the atomizer 102 and may be directly coupled to the atomizer 102.

The on-off valve 130 is connected to a valve controller of the liquid mass flow controller 104 through a signal line, and cooperates in combination with operation of a control valve of the liquid mass flow controller 104. In detail, the on-off valve 130 is simultaneously opened with the opening of the control valve and is simultaneously closed with the closing the control valve.

The atomizer 102 forms the liquid reactant into the aerosol mist and is coupled to an upper portion of a vaporizer 132 to vaporize the aerosol mist. The aerosol mist is injected into the vaporizer 132, and the gas reactant is formed in the vaporizer 132 by vaporizing the aerosol mist.

The gas supply apparatus 100, as described above, may be employed in a CVD apparatus or an ALD apparatus for forming a layer on a semiconductor substrate. Particularly, the vaporizer 132 may be connected to a reaction chamber of the layer formation apparatus such as the CVD apparatus or the ALD apparatus through a fifth gas supply conduit 134.

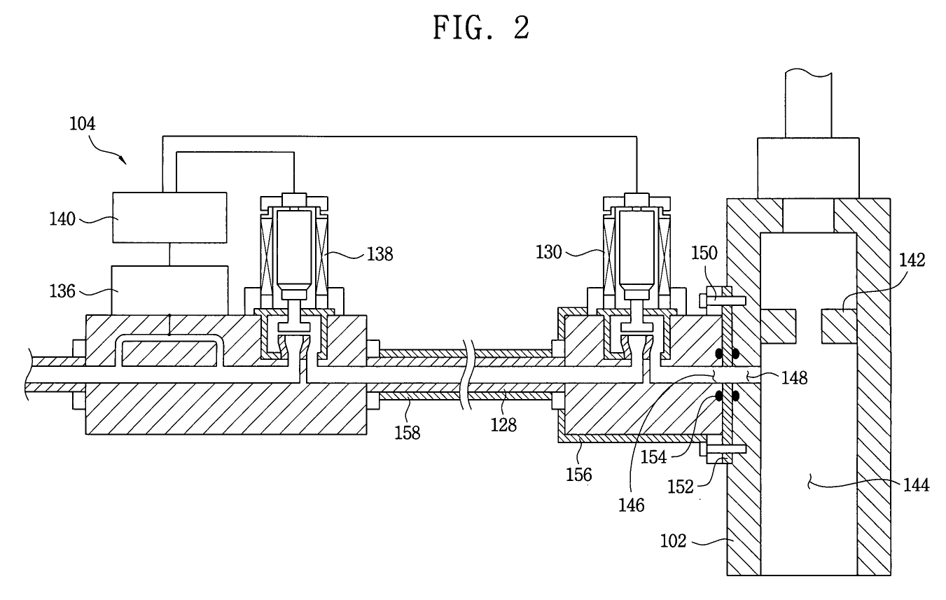

FIG. 2 is a cross-sectional view illustrating the liquid mass flow controller 104 and the on-off valve 130 as shown in FIG. 1.

Referring to FIG. 2, the liquid mass flow controller 104 includes a mass flow meter 136 for measuring the flow rate of the liquid reactant, a control valve 138 for controlling the flow rate of the liquid reactant and a valve controller 140 for controlling operation of the control valve 138 based on the flow rate measured by the mass flow meter 136.

The control valve 138 is connected to the on-off valve 130 through the second connecting conduit 128 and adjusts the flow rate of the liquid reactant according to a control signal produced by the valve controller 140. Further, the valve controller 140 is connected to the on-off valve 130 through the signal line and controls the operation of the on-off valve 130 such that the on-off valve 130 is simultaneously opened with the opening of the control valve 138 and simultaneously closed with the closing of the control valve 138. A solenoid valve may be used as the control valve 138 and the on-off valve 130. However, the scope of the present invention is not limited by the types of the control valve 138 and the on-off valve 130.

The mass flow meter 136 may include a bypass for measuring the flow rate of the liquid reactant. The mass flow meter 136 may instead include a sensor assembly for sensing thermal characteristics representing the flow rate of the liquid reactant. Examples of the mass flow meter are disclosed in U.S. Patent Application Publication Nos. 2002/0073772 and 2004/0118200.

The atomizer 102 has a cylindrical body having an open lower portion, an orifice portion 142 for passing the carrier gas therethrough and an interior space 144 in which the aerosol mist is formed. The carrier gas source 120 is connected to an upper portion of the atomizer 102 through the third gas supply conduit 122, the mass flow controller 126 and the fourth gas supply conduit 124. The carrier gas is injected into the interior space 144 of the atomizer 102 through the orifice portion 142.

An outlet 146 of the on-off valve 130 is in communication with a liquid reactant inlet 148 formed through a side wall of the atomizer 102. The liquid reactant introduced into the interior space 144 through the liquid reactant inlet 148 is formed into the aerosol mist by the pressure drop and a jet stream of the carrier gas.

The on-off valve 130 is coupled to the side wall of the atomizer 102 by means of a plurality of fasteners 150 such as a plurality of bolts. An adiabatic member 152 may be interposed between the on-off valve 130 and the atomizer 102 to prevent a high temperature heat transfer from the vaporizer 132. In addition, sealing members may be interposed between the on-off valve 130, the adiabatic member 152 and the atomizer 102. A first adiabatic jacket 156 may surround the on-off valve 130 to shut out radiant heat from the vaporizer 132.

Furthermore, a second adiabatic jacket 158 may be disposed surrounding the second connecting conduit 128, and thus the remaining liquid reactant in the second connecting conduit 128 is restrained from boiling that may be caused by the radiant heat from the vaporizer 132.

As shown in figures, though one on-off valve 130 is coupled to the side wall of the atomizer 102, a plurality of on-off valves may be coupled to the side wall of the atomizer 102. That is, various reactants may be separately introduced into the atomizer, and then a reaction gas mixture may be formed by the atomizer 102 and the vaporizer 132.

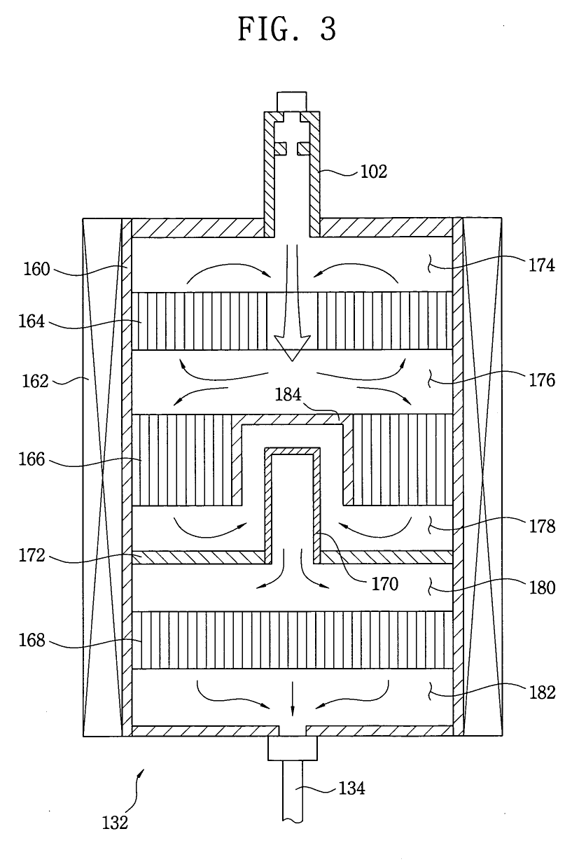

FIG. 3 is a cross-sectional view illustrating the vaporizer 132 as shown in FIG. 1.

Referring to FIG. 3, the atomizer 102 is coupled within a central hole formed in an upper panel of the vaporizer 132. The aerosol mist from the atomizer 102 is introduced into the vaporizer 132 along with the carrier gas.

The vaporizer 132 may include a cylindrical housing 160 in which the aerosol mist is introduced, a heater 162 disposed surrounding the housing 160 for vaporizing the aerosol mist so as to form the gas reactant, a plurality of heat transfer members 164, 166 and 168 disposed in the housing and a filter 170 for removing impurities and mist particles contained in the gas reactant.

Particularly, a first heat transfer member 164, a second heat transfer member 166 and a third heat transfer member 168 are disposed in series in the housing 160, and a filter bracket 172 is disposed between the second and third heat transfer members 166 and 168. The filter 170 is coupled within a central hole formed in the filter bracket 172.

Each of heat transfer members 164, 166 and 168 has a circular shape and is attached to an inner surface of the housing 160. Furthermore, each of the heat transfer members 164, 166 and 168 has a honeycomb shape in order to pass the aerosol mist and the gas reactant therethrough. Particularly, a first hole is formed in a central portion of the first heat transfer member 164, and a gas stream formed by the atomizer 102 passes through the first hole, the gas stream including the carrier gas and the aerosol mist. A plurality of second holes are formed in peripheral portions around the first hole and has a diameter smaller than that of the first hole. A third hole is formed in a central portion of the second heat transfer member 166, and a plurality of fourth holes are formed in peripheral portions around the third hole and has a diameter smaller than that of the third hole.

The aerosol mist from the atomizer 102 flows into a second space 176 between the first heat transfer member 164 and the second heat transfer member 166. Then, a part of the aerosol mist flows into a first space 174 between the upper panel of the housing 160 and the first heat transfer member 164 through the second holes of the first heat transfer member 164. A remainder of the aerosol mist flows into a third space 178 between the second heat transfer member 166 and the filter bracket 172 through the fourth holes of the second heat transfer member 166. The aerosol mist is formed into the gas reactant while flowing through the second and fourth holes. The gas reactant in the first space 174 flows into the third space 178 through the first hole, the second space 176 and the fourth holes.

As shown in FIG. 3, a cap 184 is mounted within the third hole of the second heat transfer member 166, and a part of the filter 170 is received in the cap 184. Particularly, the filter 170 includes a cylindrical body having an open lower portion and is coupled within the central hole of the filter bracket 172 to remove the impurities and the mist particles contained in the gas reactant. An outer diameter of the filter 170 is smaller than an inner diameter of the cap 184, and an upper portion of the filter 170 is spaced apart downwardly from an upper portion of the cap 184.

The gas reactant flows into a fourth space 180 between the filter bracket 172 and the third heat transfer member 168 through the filter 170. The gas reactant flows into a fifth space 182 between the third heat transfer member 168 and a lower panel of the housing 160 through a plurality of fifth holes formed in the third heat transfer member 168. Finally, the gas reactant is introduced into the reaction chamber through the fifth gas supply conduit 134 connected to the lower panel of the housing 160.

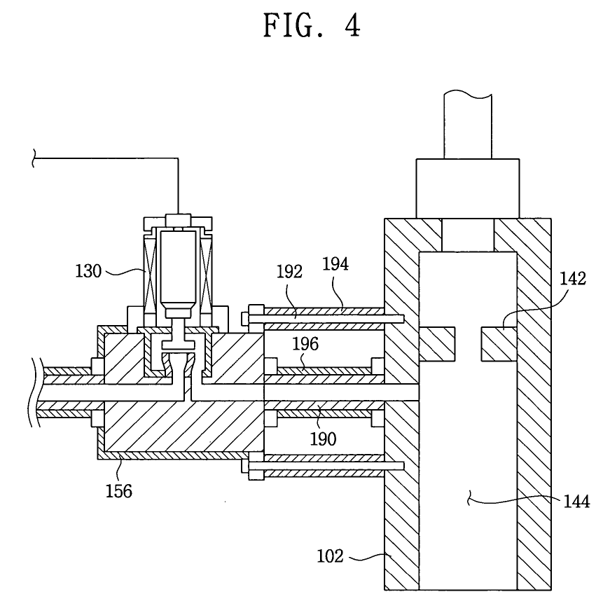

FIG. 4 is a cross-sectional view illustrating another example of coupling relationship between the on-off valve 130 and the atomizer 102 as shown in FIG. 2.

Referring to FIG. 4, the on-off valve 130 may be connected to the atomizer 102 by a third connecting conduit 190. Particularly, it is desirable that the third connecting conduit 190 has a length short enough to minimize an amount of the remaining liquid reactant in the third connecting conduit 190. For example, the length of the third connecting conduit 190 may be about 0.5 to about 3.0 centimeters (cm).

The on-off valve 130 may be mounted to the atomizer 102 by a plurality of fasteners 192 such as a plurality of bolts. Particularly, a plurality of spacers 194 are disposed between the on-off valve 130 and the atomizer 102, and the fasteners 192 are threadably engaged with the side wall of the atomizer 102 through the spacers 192. For example, adiabatic tubes may be used as the spacers 194. A third adiabatic jacket 196 may be disposed surrounding the third connecting conduit 190 to shut out the radiant heat from the vaporizer 132.

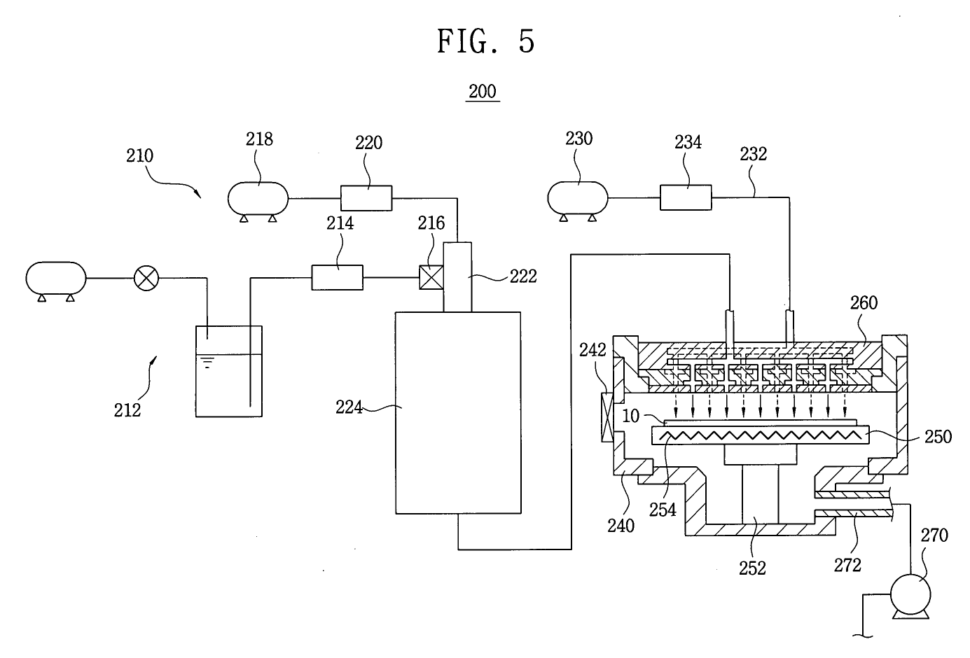

FIG. 5 is a schematic view illustrating an apparatus for forming a layer in accordance with another example embodiment of the present invention.

Referring to FIG. 5, a layer forming apparatus 200 may include a first gas supply unit 210 for supplying a first gas reactant, a second gas supply unit 230 for supplying a second gas reactant, a reaction chamber 240 connected to the first and second gas supply units 210 and 230 and a chuck 250 disposed in the reaction chamber 240 for supporting a semiconductor substrate 10. The chuck is mounted on a supporting member 252 disposed in a lower portion of the reaction chamber 240 and has a heater 254 built-in. The heater 254 is employed for heating the semiconductor substrate 10 to a reaction temperature.

A shower head 260 is disposed over the chuck 250 for uniformly supplying the gas reactants onto the semiconductor substrate 10, and the first and second gas supply units 210 and 230 are in communication with the reaction chamber 240 through the shower head 260.

A gate valve 242 is disposed in a side wall of the reaction chamber 240 so that the semiconductor substrate 10 comes in and out. A vacuum system 270 is connected to a lower side wall of the reaction chamber 240 through a vacuum conduit 272 in order to adjust an interior pressure of the reaction chamber 240, to remove by-products from the reaction chamber generated while forming the layer and to remove remaining gas reactants from the reaction chamber 240.

The first gas supply unit 210 may include a liquid reactant supply section 212 for supplying a first liquid reactant, a liquid mass flow controller 214 for controlling a flow rate of the first liquid reactant, an on-off valve 216 cooperating in combination with the liquid mass flow controller 214, a carrier gas source 218 for supplying a carrier gas, a first mass flow controller 220 for controlling a flow rate of the carrier gas, an atomizer 222 for forming the first liquid reactant into an aerosol mist and a vaporizer 224 for vaporizing the aerosol mist. In such a case, further detailed descriptions of the first gas supply unit 210 will be omitted because these elements of the first gas supply unit 210 are substantially similar to those already described in connection with the apparatus 100 for supplying gas as shown in FIGS. 1 to 4.

The second gas supply unit 230 is connected to the shower head 260 through a sixth gas supply conduit 232. A second mass flow controller 234 is disposed in the sixth gas supply conduit 232 to control a flow rate of the second gas reactant. Furthermore, not shown in the figures, a remote plasma generator may be disposed in the sixth gas supply conduit 232 to convert the second gas reactant into plasma.

For example, when forming a hafnium oxide layer on the semiconductor substrate 10 using the layer formation apparatus 200, Tetrakis Ethyl Methyl Amino Hafnium (TEMAH) may be commonly used as the first gas reactant, and ozone (O₃) or oxygen (O₂) plasma may be commonly used as the second gas reactant.

On the contrary, when forming a titanium nitride layer on the semiconductor substrate 10 using the layer formation apparatus 200, Tetrakis Ethyl Methyl Amino Titanium (TEMAT) may be commonly used as the first gas reactant, and ammonia (NH₃) or nitrogen (N₂) plasma may be commonly used as the second gas reactant.

Furthermore, the shower head 260 may be electrically connected to a RF (radio frequency) power source to form the gas reactants into a plasma phase. In such case, the chuck 250 may be electrically connected to a bias power source.

As shown in the figures, though the first and second gas supply units 210 and 230 are connected to the reaction chamber 240 of a single substrate type, the first and second gas supply units 210 and 230 may be connected to a batch-type of reaction chamber. Particularly, the first and second gas supply units 210 and 230 may be connected to a vertical furnace for performing a deposition process on a plurality of semiconductor substrate supported in a boat. That is, the spirit and scope of the present invention is not limited by a type of reaction chamber, and the first and second gas supply units 210 and 230 may be desirably employed to various types of layer formation apparatuses for forming a layer on a substrate.

According to the example embodiments of the present invention, the liquid mass flow controller for controlling the flow rate of the liquid reactant is spaced apart from the vaporizer for vaporizing the liquid reactant, and thus the liquid mass flow controller may be stably operated. Further, the on-off valve may prevent leakage of the remaining liquid reactant in the connecting conduit between the liquid mass flow controller and the atomizer during downtime of the apparatus. Thus, contamination due to the leakage of liquid reactant may be prevented, and a feeding time of gas reactant may be reduced in a layer deposition process.

Although example embodiments of the present invention have been described, it is understood that the present invention should not be limited to these example embodiments but various changes and modifications can be made by one skilled in the art within the spirit and scope of the present invention as hereinafter claimed.

1. A gas supplying apparatus comprising:
a liquid reactant supply section structured to supply a liquid reactant;
an atomizer arranged and structured to form an aerosol mist from the liquid reactant;
a liquid mass flow controller disposed in a connecting conduit between the liquid reactant supply section and the atomizer and structured to control a flow rate of the liquid reactant;
a vaporizer coupled to the atomizer and structured to vaporize the aerosol mist to form a gas reactant; and
a valve disposed in the connecting conduit adjacent to the atomizer and structured to cooperate in combination with an operation of the liquid mass flow controller.

2. The apparatus of claim 1, wherein the liquid mass flow controller includes:
a mass flow meter to measure the flow rate of the liquid reactant,
a control valve to control the flow rate of the liquid reactant, and
a valve controller to control an operation of the control valve based on the flow rate measured by the mass flow meter.

3. The apparatus of claim 2, wherein the valve disposed in the connecting conduit adjacent to the atomizer is structured to simultaneously open with an opening of the control valve and to simultaneously close with a closing of the control valve.

4. The apparatus of claim 1, wherein the liquid reactant supply section includes a container structured to receive the liquid reactant and a source of compressed gas to introduce a compressed gas into the container.

5. The apparatus of claim 1, wherein the connecting conduit includes a first connecting conduit connecting the liquid reactant supply section to the liquid mass flow controller and a second connecting conduit connecting the liquid mass flow controller to the valve,
and the valve is directly coupled to the atomizer.

6. The apparatus of claim 5, further comprising an adiabatic member interposed between the valve and the atomizer.

7. The apparatus of claim 5, further comprising a first adiabatic jacket surrounding the valve and a second adiabatic jacket surrounding the second connecting conduit.

8. The apparatus of claim 1, wherein the connecting conduit includes
a first connecting conduit connecting the liquid reactant supply section to the liquid mass flow controller,
a second connecting conduit connecting the liquid mass flow controller to the valve, and
a third connecting conduit connecting the valve to the atomizer.

9. The apparatus of claim 8, further comprising:
a plurality of spacers disposed between the valve and the atomizer; and
a plurality of fasteners coupling the valve to the atomizer.

10. The apparatus of claim 8, wherein the third connecting conduit has a length of about 0.5 centimeters (cm) to about 3.0 cm.

11. The apparatus of claim 8, further comprising an adiabatic jacket surrounding the third connecting conduit.

12. The apparatus of claim 1, further comprising a source of carrier gas connected to the atomizer to introduce a carrier gas into an interior space of the atomizer.

13. The apparatus of claim 12, further comprising a carrier gas mass flow controller to control a flow rate of the carrier gas.

14. The apparatus of claim 13, wherein the atomizer has an orifice structured to inject the carrier gas into the interior space of the atomizer, and the atomizer is structured to introduce the liquid reactant into the interior space of the atomizer.

15. The apparatus of claim 1, wherein the vaporizer includes a housing, the vaporizer structured to introduce the aerosol mist into the housing,
and a heater surrounding the housing to vaporize the aerosol mist to form the gas reactant.

16. The apparatus of claim 15, wherein the vaporizer includes a plurality of heat transfer members disposed in series in the housing to pass the aerosol mist and the gas reactant therethrough and includes a filter disposed between the heat transfer members to remove impurities and mist particles in the gas reactant.

17. The apparatus of claim 16, wherein each of the heat transfer members has a honeycomb shape to pass the aerosol mist and the gas reactant therethrough and to vaporize the aerosol mist.

18. The apparatus of claim 15, wherein the atomizer is coupled to an upper panel of the vaporizer.

19. A layer forming apparatus comprising:
a reaction chamber structured and arranged to receive a substrate to form a layer on the substrate;
a substrate support disposed in the reaction chamber;
a gas supply unit to supply a gas reactant into the reaction chamber to form the layer, the gas supply unit including:
a liquid reactant supply section,
an atomizer to form the liquid reactant into an aerosol mist,
a liquid mass flow controller disposed in a connecting conduit between the liquid reactant supply section and the atomizer to control a flow rate of the liquid reactant,
a valve disposed in the connecting conduit adjacent to the atomizer and structured to cooperate in combination with an operation of the liquid mass flow controller, and
a vaporizer coupled to the atomizer to vaporize the aerosol mist to form the gas reactant; and
a vacuum system connected to the reaction chamber to adjust an interior pressure of the reaction chamber, to remove by-products generated while forming the layer from the reaction chamber and to remove a remaining gas reactant from the reaction chamber.

20. The apparatus of claim 19, wherein the liquid mass flow controller includes:
a mass flow meter to measure the flow rate of the liquid reactant,
a control valve to control the flow rate of the liquid reactant, and
a valve controller to control an operation of the control valve based on the flow rate measured by the mass flow meter.

21. The apparatus of claim 19, further comprising a second gas supply unit to supply a second gas reactant into the reaction chamber.
